(19) United States
(12) Patent Application Publication
(10) Pub. No.: US 2002/0153144 A1
(43) Pub. Date: Oct. 24, 2002

(54) Metal matrix composite horseshoe

(76) Inventor: Samuel C. Weaver, Knoxville, TN (US)

Correspondence Address: Cohen & Grigsby PC, 11 Stanwix Street, 15th Floor, Pittsburgh, PA, 15222, US

(21) Appl. No.: 09/838,866

(22) Filed: Apr. 20, 2001

(51) Int. Cl. A01L 1/00; A01L 3/00; A01L 5/00

(52) U.S. Cl. 168/4

(57) ABSTRACT

A horseshoe is made from a metal matrix composite. The metal matrix contains particles of a silicon boride composition. The preferred metal is aluminum and the preferred form of the silicon boride is silicon hexaboride. The horseshoe is lightweight and has superior wear resistance and good vibration damping characteristics.

### FIELD OF THE INVENTION

The present invention relates to a horseshoe having a composition of silicon boride particles in a metal matrix.

### BACKGROUND OF THE INVENTION

Conventional horseshoes have been made mainly of mild steel and are quite heavy, making them inappropriate for use in many situations. For instance, lighter weight shoes should be used for young horses whose legs are not yet strong enough for conventional shoes. Lightweight shoes are often used in horse racing. They may also be useful where a horse has injured its leg and should not wear the heavier shoes while the leg heals.

In the past light weight shoes have usually been formed by making a shoe out of a light metal, usually aluminum with steel inserts or calks placed at the points of expected wear. Such shoes, however, have been found to have both poor wear and poor strength characteristics. Generally, use of lightweight metals without inserts in horseshoes has been found to produce the same type of problems: rapid wear and severely reduced strength when compared to the standard steel or iron horseshoes.

Modern practice of farriery recognizes that there are many applications which require light weight horseshoes in preference to the conventional iron or steel shoes. However, the lightweight shoes should provide wear and strength properties comparable to the heavier conventional shoes. Consequently, it would be desirable to have a lightweight horseshoe that has wear and strength characteristics equivalent to heavier conventional shoes.

### OBJECTS OF THE INVENTION

Accordingly, it is an object of the present invention to provide a lightweight horseshoe having improved wear resistance and good vibration damping characteristics. Further and other objects of the present invention will become apparent from the description contained herein.

### SUMMARY OF THE INVENTION

In accordance with one aspect of the present invention, a new and improved horseshoe comprises a metal matrix composite. The metal matrix composite is formed from a molten metal selected from the group consisting of aluminum, magnesium, titanium and mixtures thereof, and particles of silicon boride composition selected from the group consisting, of silicon tetraboride, silicon hexaboride and mixtures thereof. The silicon boride composition is present in a range from about 0.1 to about 80 weight percent in the molten metal.

### DETAILED DESCRIPTION OF THE PREFERRED EMBODIMENTS

A horseshoe of the present invention was fabricated from a metal matrix composite of silicon hexaboride particles and aluminum. This metal matrix composite is described in U.S. Pat. No. 5,573,607 and is hereby incorporated herein by reference. The silicon hexaboride was prepared by a substantially commercial process. Since the specific gravity of the hexaboride is very close to that of aluminum, only a minimal amount of stirring was required to achieve a homogeneous mixture. If heating is accomplished in an induction furnace, a stirring action is automatically achieved. Some mechanical stirring is required under other conditions of heating.

While a range of compositions of from about 0.1 weight percent to about 80 weight percent of silicon hexaboride can be utilized relative to the aluminum, a range of about 10 weight percent to about 45 weight percent is most practical for most applications and was utilized for testing. The silicon hexaboride typically had an average particle size of about 20 micrometers, although a range of about 0.1 to about 200 micrometers can be used. In a preferred form of the invention, the silicon hexaboride is generally rounded (e.g., spheroidal). The addition of the silicon hexaboride to the molten metal was principally utilized in the development of the present invention.

However, it will be understood that the invention also includes the blending of the silicon hexaboride particles with powdered aluminum metal and any other alloying constituents prior to melting the mixture. The molten mixture has been cast into a desired shape of a horseshoe.

Magnesium and titanium have low specific gravities similar to that of aluminum. Accordingly, metal matrix composites of these metals with silicon hexaboride and similar silicon borides are within the scope of the present invention.

Certain other silicon boride compositions have specific gravity values close to that of silicon hexaboride. For example, silicon tetraboride is expected to perform in a manner similar to that of the silicon hexaboride. Similarly, these compounds with a small amount of carbon (typically less than 25 weight percent) are within the scope of the present invention.

From the foregoing, it will be understood that improved metal matrix composites of aluminum, magnesium and titanium are achieved by the addition of a silicon boride material. Specificaltly, silicon tetraboride and silicon hexaboride are of value, with the silicon hexaboride being of greatest value. The composition can be easily prepared with a minimum of stirring, and the product can be recycled if desired.

The metal matrix composites used to make the horseshoes of the present invention have unexpected good wear behavior. For example, samples made from the 10 weight percent silicon hexaboride particles in an aluminum matrix had 7 times better wear than 17.5 weight percent silicon carbide particles in an aluminum matrix and 30 times better than straight aluminum. In addition, these samples had unexpectedly good vibration damping. The good vibration damping will reduce the shock to the horses' legs. The lightweight of the material will make the shoes more comfortable for the horse and the good wear resistance will eliminate the drawback of other lightweight horseshoes.

While there has been shown and described what is at present considered the preferred embodiments of the invention, it will be obvious to those skilled in the art that various changes and modifications may be made therein without departing from the scope of the invention as defined by the appended claims.

I claim:

1. A horseshoe comprising a metal matrix composite, said metal matrix composite being formed from a molten metal selected from the group consisting of aluminum, magnesium, titanium and mixtures thereof, and particles of silicon boride composition selected from the group consisting of silicon tetraboride, silicon hexaboride and mixtures thereof, said silicon boride composition being present in a range from about 0.1 to about 80 weight percent in said molten metal.

2. A horseshoe in accordance with claim 1 wherein said silicon boride composition is silicon hexaboride.

3. A horseshoe in accordance with claim 2 wherein said silicon hexaboride has an average particle size of about 0.1 to about 200 micrometers.

4. A horseshoe in accordance with claim 3 wherein said silicon hexaboride has an average particle size of about 20 micrometers.

5. A horseshoe in accordance with claim 1 wherein said molten metal is aluminum.

6. A horseshoe in accordance with claim 4 wherein said molten metal is aluminum.

7. A horseshoe in accordance with claim 1 wherein said silicon boride composition is present in a range from about 10 to about 45 weight percent.

8. A horseshoe in accordance with claim 3 wherein said silicon hexaboride is present in a range from about 10 to about 45 weight percent.

9. A horseshoe comprising a metal matrix composite, said metal matrix composite being formed from molten aluminum metal and particles of silicon boride composition selected from the group consisting of silicon tetraboride, silicon hexaboride and mixtures thereof, said silicon boride composition being present in a range from about 0.1 to about 80 weight percent in said molten metal.

10. A horseshoe in accordance with claim 9 wherein said silicon boride composition is silicon hexaboride.

11. A horseshoe in accordance with claim 10 wherein said silicon hexaboride has an average particle size of about 0.1 to about 200 micrometers.

12. A horseshoe in accordance with claim 10 wherein said silicon hexaboride has an average particle size of about 20 micrometers.

13. A horseshoe in accordance with claim 9 wherein said silicon boride composition is present in a range from about 10 to about 45 weight percent.

14. A horseshoe in accordance with claim 10 wherein said silicon hexaboride is present in a range from about 10 to about 45 weight percent.

15. A horseshoe comprising a metal matrix composite, said metal matrix composite being formed from molten aluminum metal and particles of silicon hexaboride particles having an average particle of 20 micrometers and being present in a range from about 0.1 to about 80 weight percent in said molten aluminum metal.

16. A horseshoe in accordance with claim 15 wherein said silicon hexaboride is present in a range from about 10 to about 45 weight percent in the molten aluminum metal.
